(19) United States
(12) Patent Application Publication
(10) Pub. No.: US 2006/0115647 A1
(43) Pub. Date: Jun. 1, 2006

(54) Stick-on nameplate for a measuring instrument

(76) Inventor: Arnoud Leendert van Willigen, Capelle aan den Ijssel (NL)

Correspondence Address: CESARI AND MCKENNA, LLP, 88 BLACK FALCON AVENUE, BOSTON, MA, 02210, US

(21) Appl. No.: 11/079,608

(22) Filed: Mar. 14, 2005

(30) Foreign Application Priority Data
Dec. 1, 2004 (DE) 10 2004 058 090.1
Dec. 20, 2004 (DE) 10 2004 062 322.8

(51) Int. Cl. B32B 7/12

(52) U.S. Cl. 428/354; 428/343

(57) ABSTRACT

A stick-on nameplate for a measuring instrument, with an adhesive layer serving to attach the nameplate on a surface of the measuring instrument, and with a superstratum to be imprinted for labeling purposes in which a diffusion-inhibiting intermediate layer is interpositioned between the adhesive layer and the superstratum. As a result, an aggressive substance present in a hazardous location cannot penetrate all the way to the adhesive layer and damage it, so that a secure adhesive bond between the nameplate and the measuring instrument is ensured for a long time.

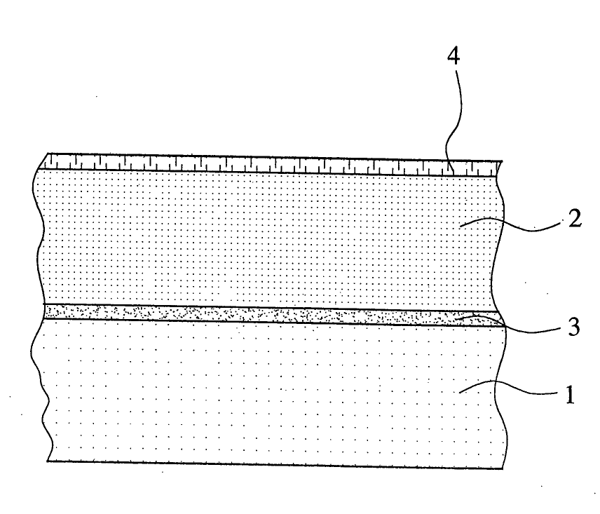

This invention relates to a stick-on nameplate for a measuring instrument, with an adhesive layer for attaching the nameplate on a surface of the measuring instrument and a superstratum provided for labeling.

### BACKGROUND OF THE INVENTION

Measuring instruments are usually provided with a nameplate that shows all the information pertaining to the measuring instrument such as model name, serial number, technical data including electrical specifications etc. Traditionally these nameplates have been in the form of a stick-on nameplate as referred to above or as a metal plate attached to the measuring instrument, for instance with screws. The latter type of metal plates that are attached to the measuring instrument, for instance with screws, are used in particular for measuring instruments deployed in a hazardous location. Hazardous locations as referred to in this case are areas exposed to high concentrations of aggressive or corrosive substances.

To ensure that a nameplate on a measuring instrument that is operated in such a hazardous location remains permanently attached, various tests, lasting a certain length of time such as six to ten days, expose a measuring instrument with that type of nameplate to a very high concentration of an aggressive substance such as a fifty-percent saturated atmosphere of ethanol, ethyl acetate, petrolether, methyl ethyl ketone, toluene, acetone, hexane, methanol or acetic acid. If during that test period the nameplate does not peel off, that nameplate is approved for use in hazardous locations. As an example, reference is made to the USA “Approval Standard for Electrical Equipment for Use in Hazardous (Classified) Locations-General Requirements, Class Number 3600, November 1998”, as well as to Regulation “C22.2 no. 30-M1986 (R1999) for DIV1/DIV2 Hazardous Locations” of the Canadian Standards Association.

Stick-on nameplates have not so far been used in such hazardous locations since it has not been possible to ensure that the adhesive layer of such nameplates remains securely bonded to the measuring instrument. After all, a nameplate that comes off or is in fact lost creates a problem in that a measuring instrument without the data on the nameplate cannot usually be safely employed any longer.

### SUMMARY OF THE INVENTION

It is therefore the objective of this invention to introduce a nameplate of the above type for a measuring instrument that can be used in simple and safe fashion in a hazardous location as well.

For a nameplate as referred to above, this objective is achieved by interpositioning between the adhesive layer and the superstratum a diffusion-inhibiting intermediate layer.

The invention is based on the realization that the problem compromising durable adhesion of the nameplate on the surface of the measuring instrument is caused by a diffusion through the layers above the adhesive layer, such as the superstratum that is used for labeling. For example, if the aggressive substance that is present in the hazardous location penetrates by diffusion the layers above the adhesive layer and reaches the adhesive layer itself, it can damage the latter, potentially compromising its function to a point where the nameplate falls off. The nameplate may also be caused to separate in situations where, upon diffusion through the layers above the adhesive layer, the aggressive substance attacks and dissolves the coat of paint on the outer wall of the measuring instrument underneath the adhesive layer, in which case the nameplate may again become loose and fall off.

The invention addresses that problem in that an intermediate layer is sandwiched between the superstratum and the adhesive layer that serves to attach the nameplate on the surface of the measuring instrument, which intermediate layer is designed to inhibit the diffusion of the aggressive substance that is present in the hazardous location. Since the thickness of nameplates is typically about 100 μm and often less than that, the aggressive substance is most unlikely to penetrate the lateral faces of the nameplate all the way to the adhesive layer. The diffusion-inhibiting layer above the adhesive layer thus substantially blocks virtually the entire access path to the adhesive layer. Only an extremely minute concentration of the aggressive substance makes contact with the adhesive layer, keeping the stable bond between the nameplate and the surface of the measuring instrument intact for a long time.

For an enduring bond between the nameplate and the surface of the measuring instrument, it is helpful if the diffusion-inhibiting intermediate layer covers at least part of the adhesive layer. However, a preferred embodiment of the invention provides for the diffusion-inhibiting intermediate layer to cover all of the adhesive layer, and that, in particular, the diffusion-inhibiting intermediate layer extends over the entire visible surface of the nameplate.

The diffusion-inhibiting intermediate layer can consist of any one of several materials that may be selected depending on the aggressive substance in the hazardous location. According to a preferred form of implementation of the invention, however, the diffusion-inhibiting intermediate layer contains a metallic material such as aluminum, silver or platinum. These materials have been found to inhibit diffusion in a very general sense, i.e. for a great many possible substances in hazardous locations, thus offering extremely effective protection of the adhesive bond.

Of course, the effectiveness of the diffusion-inhibiting intermediate layer can be generally assumed to increase with the thickness of the layer. However, if a very thick diffusion-inhibiting intermediate layer is used, and especially if it is metallic, other problems will arise, especially due to the fact that the stick-on nameplate is no longer easy and convenient to handle. Therefore, especially when a metallic material is used, the invention provides for a diffusion-inhibiting intermediate layer whose thickness is selected between 5 μm and 0.1 μm, but preferably at approximately 1 μm.

There are now numerous possible ways in which the nameplate according to this invention can be configured and further enhanced. In that context, attention is invited to the independent patent claims as well as to the following description of a preferred embodiment of the invention with reference to the attached drawing.

### BRIEF DESCRIPTION OF THE DRAWING

The sole FIGURE is a schematic cross-sectional view of a stick-on nameplate according to a preferred embodiment of the invention.

### DETAILED DESCRIPTION OF AN ILLUSTRATIVE

### EMBODIMENT

The stick-on nameplate shown in the drawing FIGURE, representing a preferred embodiment of the invention, includes an adhesive layer 1 for attaching the nameplate on the surface of a measuring instrument, not illustrated, as well as a superstratum 2 to be imprinted for labeling purposes. The stick-on nameplate can equally well be attached on a support plate mounted on the measuring instrument for instance with screws, nails, a wire or other means. Interpositioned between the adhesive layer 1 and the superstratum 2 is a diffusion-inhibiting intermediate layer 3 consisting of aluminum. The superstratum 2 on its part is covered with a surface coating 4 designed to facilitate the labeling on the nameplate according to the preferred embodiment of the invention described here by means, for instance, of a thermal transfer printer or a laser printer.

The illustration in the FIGURE is purely schematic and especially not to scale. In the preferred embodiment of the invention here described, the thickness of the adhesive layer is about 50 μm, that of the metallic layer is about 0.03 μm, that of the superstratum is about 50 μm and that of the surface coating is about 1 μm.

The material for the adhesive layer may be any popular adhesive including those used for attaching nameplates that are not intended for hazardous locations. This is made possible by the interpositioning of the diffusion-inhibiting intermediate layer between the adhesive layer and the superstratum, which to a substantial extent shields the adhesive layer from the effect of aggressive substances in a hazardous location. The superstratum, on its part, can consist of any one of many different materials, a typical material being polyester.

Nameplates of the type described above offer considerable advantages over prior-art nameplates for use in hazardous locations.

The cost of materials and manufacturing for a stick-on nameplate is substantially lower than that of producing a metal plate. The latter also requires the specifications to be engraved, which involves a special procedural step. By contrast, stick-on nameplates with a superstratum that may be imprinted with a laser or ink-jet printer can be produced virtually on demand, meaning at the time the measuring instrument concerned is completed. This also makes it possible at the time the measuring instrument is labeled to take into account the very latest data updates reflecting information that was not as yet available before completion of the measuring instrument.

Moreover, stick-on nameplates are easier to attach on the curved surfaces of a measuring instrument. For easier manipulation when stick-on nameplates are to be attached to a curved surface on the measuring instrument, the superstratum should be as thin as possible, certainly thinner than when the nameplate is to be attached on a flat surface of the measuring instrument.

What is claimed is:

1. A stick-on nameplate for a measuring instrument, with an adhesive layer serving to attach the nameplate on a surface of the measuring instrument and with a superstratum to be imprinted for labeling purposes, wherein a diffusion-inhibiting intermediate layer is interpositioned between the adhesive layer and the superstratum.

2. The stick-on nameplate as in claim 1, wherein the diffusion-inhibiting intermediate layer completely covers the adhesive layer.

3. The stick-on nameplate as in claim 1 or 2, wherein the diffusion-inhibiting intermediate layer contains a metallic material such as aluminum, silver or platinum.

4. The stick-on nameplate as in claim 3, wherein the diffusion-inhibiting intermediate layer consists of a metal.

5. The stick-on nameplate as in claim 1 or 2, wherein the thickness of the diffusion-inhibiting intermediate layer is less than 5 μm and is preferably about 0.03 μm.

6. Use of a nameplate with an adhesive layer serving to attach the nameplate on a surface of a measuring instrument and with a superstratum to be imprinted for labeling purposes according to claim 1 or 2, in a hazardous location and in particular on a measuring instrument designed for deployment in a hazardous location.

7. A method of producing for a measuring-instrument nameplate according to claim 1 or 2, wherein the nameplate is imprinted entirely ‘on demand’ immediately prior to being attached to the measuring instrument.
